(19) United States
(12) Patent Application Publication
(10) Pub. No.: US 2022/0108274 A1
(43) Pub. Date: Apr. 7, 2022

(54) AUTOMATED SYSTEM FOR ADMINISTERING ITERATIONS IN A CONTINUOUS SOFTWARE DEVELOPMENT LIFECYLE FRAMEWORK

(71) Applicant: BANK OF AMERICA CORPORATION, Charlotte, NC (US)

(72) Inventors: Madhusudhanan Krishnamoorthy, Chennai (IN); Uma Maheswari Krishnaswami, Chennai (IN); Nityashree Pannerselvam, Chennai (IN)

(73) Assignee: BANK OF AMERICA CORPORATION, Charlotte, NC (US)

(21) Appl. No.: 17/060,489

(22) Filed: Oct. 1, 2020

(51) Int. Cl. G06Q 10/10; G06F 8/71; G06Q 10/06; G06F 40/35

(52) U.S. Cl. CPC G06Q 10/103; G06F 40/35; G06Q 10/06316; G06F 8/71

(57) ABSTRACT

A system for administering iterations in a continuous software development lifecycle framework is provided. In particular, the system may be configured to gather one or more requirements from one or more entity systems associated with an entity, gather information associated with the one or more requirements and one or more users from the one or more entity systems, wherein the one or more users are associated with the entity, process the one or more requirements and the information via a natural language processing engine to generate transformed information, identify one or more conflicts associated with the one or more requirements, identify one or more exposures associated with the one or more requirements, and generate one or more decisions based on the transformed information, the one or more conflicts, and the one or more exposures.

### BACKGROUND

Conventional systems do not have the capability to automatically administer iterations associated with an entity. As such, there exists a need for a system to automatically administer iterations in a continuous software development lifecycle framework.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for automatically administering iterations in a continuous software development lifecycle framework. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention gathers one or more requirements from one or more entity systems associated with an entity, gathers information associated with the one or more requirements and one or more users from the one or more entity systems, wherein the one or more users are associated with the entity, processes the one or more requirements and the information via a natural language processing engine to generate transformed information, identifies one or more conflicts associated with the one or more requirements, identifies one or more exposures associated with the one or more requirements, generates one or more decisions based on the transformed information, the one or more conflicts, and the one or more exposures.

In some embodiments, the present invention presents the one or more decisions to the one or more users associated with the one or more entity systems, receives feedback associated with the one or more decisions from the one or more users, and generates an implementation package based on the feedback received from the one or more users and the one or more decisions.

In some embodiments, the present invention automatically administers iterations in a software development lifecycle framework based on the implementation package, wherein the implementation package comprises a number of the iterations associated with implementation of the one or more requirements, wherein administering the iterations comprises assigning one or more iterative version numbers in the software development lifecycle framework.

In some embodiments, the present invention automatically assigns each of the one or more requirements to the one or more users based on the generated implementation package, wherein the implementation package comprises assignments associated with each of the one or more requirements.

In some embodiments, the one or more requirements are associated with organizational activities associated with the entity.

In some embodiments, the information associated with the one or more requirements comprises historical assignment data associated with one or more historical assignments, technology data associated with the one or more historical assignments, and user information associated with the one or more users.

In some embodiments, the present invention generates the one or more decisions based on performing vectorization of the transformed information, the one or more conflicts, and the one or more exposures and generating one or more probabilities associated with the one or more requirements and the one or more users.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automatically administering iterations in a continuous software development lifecycle framework, in accordance with an embodiment of the invention;

FIG. 2 provides a block diagram illustrating the entity system 200 of FIG. 1, in accordance with an embodiment of the invention;

FIG. 3 provides a block diagram illustrating an iteration administering system 300 of FIG. 1, in accordance with an embodiment of the invention;

FIG. 4 provides a block diagram illustrating the computing device system 400 of FIG. 1, in accordance with an embodiment of the invention;

FIG. 5 provides a block diagram illustrating a process flow for automatically administering iterations in a continuous software development lifecycle framework, in accordance with an embodiment of the invention; and

FIGS. 6A, 6B, and 6C provide block diagrams illustrating probabilities generated by the iteration administering system 300 of FIG. 1, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “entity” may be any organization that is associated with development, management, and/or testing of software applications. Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources provided by an entity or the system of the present invention. In a specific embodiment, the user may be an employee of the entity. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, organizational activities are implemented by one or more users and one or more software applications. For development of the one or more software applications, users of the entity meet in person to go over the requirements associated with organization activities and finalize details associated with the requirements. This process typically takes four to five days and is prone to errors. The software applications are developed in a development environment, tested in a testing environment, and released into a production environment in an incremental process via a software development lifecycle framework. In the case where the finalized details are flawed, additional incremental cycles are required to correct the flaws, thereby reducing the overall efficiency of the process. As such, there exists a need for a system that administers iterations in a software development lifecycle framework.

The system of the present invention identifies the one or more requirements, one or more teams involved, historical allocation of requirements to the one or more teams, dependencies associated with the current requirements, and technology involved with each of the current requirements and calculates number of iterations that are required for implementation of the current requirements. The system also administers the one or more iterations by assigning a technology for the development of the one or more requirements and assigning the one or more requirements to the one or more teams such that there are no conflicts and the one or more requirements are fulfilled in a timely manner.

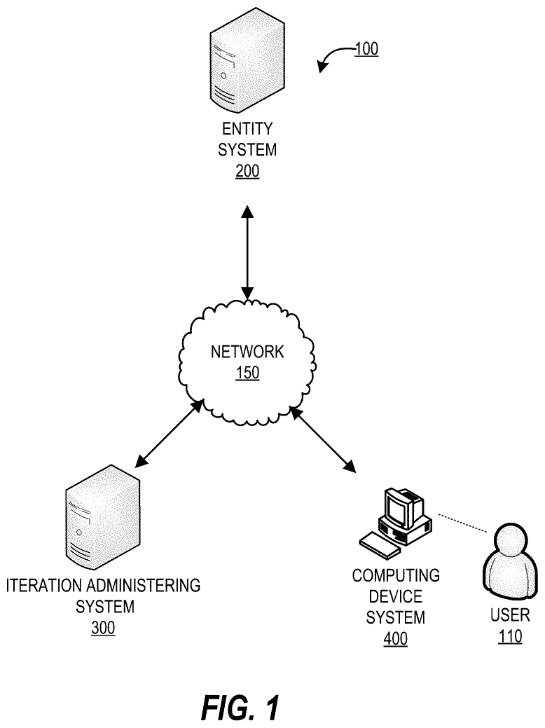

FIG. 1 provides a block diagram illustrating a system environment 100 for automatically administering iterations in a continuous software development lifecycle framework, in accordance with an embodiment of the invention. As illustrated in FIG. 1, the environment 100 includes a iteration administering system 300, entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200. In some embodiments, the users may be developers that develop one or more software applications associated with the entity of the entity system 200.

The entity system(s) 200 may be any system owned or otherwise controlled by an entity to support or perform one or more process steps described herein. In some embodiments, the entity is a financial institution. In some embodiments, the entity is a non-financial institution.

The iteration administering system 300 is a system of the present invention for performing one or more process steps described herein. In some embodiments, the iteration administering system 300 may be an independent system. In some embodiments, the iteration administering system 300 may be a part of the entity system 200.

The iteration administering system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the iteration administering system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In some embodiments of the present invention, the computing device of the user may be an employee associated with a governance team that oversees the decompiling process. In general, the computing device system 400 communicates with the user 110 via a user interface of the computing device system 400, and in turn is configured to communicate information or instructions with the iteration administering system 300, and/or entity system 200 across the network 150.

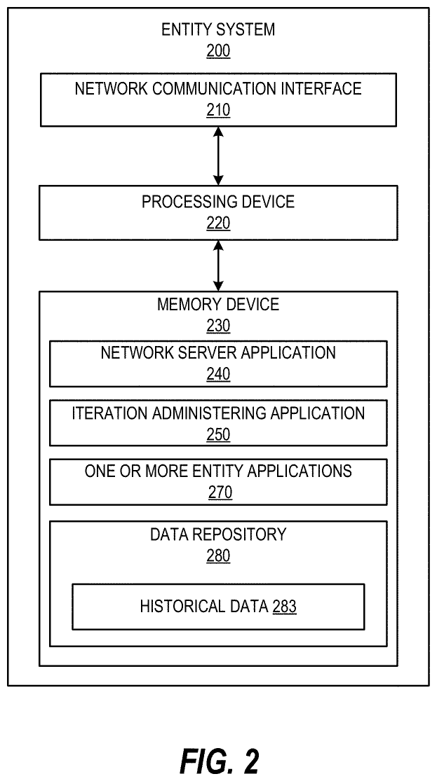

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution. In some embodiments, the entity system may be operated by any entity that is associated with developing, maintaining, and/or testing software applications.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an iteration administering application 250, one or more entity applications 270, and a data repository 280 comprising historical data 283, where the historical data 283 comprises historical data associated with implementation of previous requirements of the organization. In some embodiments, the data repository 280 also comprises data associated with the one or more users 110. The computer-executable program code of the network server application 240, the iteration administering application 250, the one or more entity application 270 to perform certain logic, data-extraction, and data-storing functions of the entity system 200 described herein, as well as communication functions of the entity system 200.

The network server application 240, the iteration administering application 250, and the one or more entity applications 270 are configured to store data in the data repository 280 or to use the data stored in the data repository 280 when communicating through the network communication interface 210 with the iteration administering system 300, and/or the computing device system 400 to perform one or more process steps described herein. In some embodiments, the entity system 200 may receive instructions from the iteration administering system 300 via the iteration administering application 250 to perform certain operations. The iteration administering application 250 may be provided by the iteration administering system 300. The one or more entity applications 270 may be any of the applications used, created, modified, and/or managed by the entity system 200 to perform one or more organizational activities.

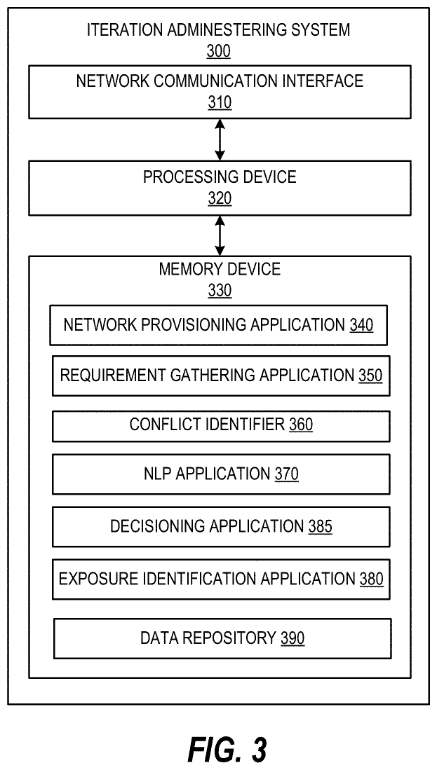

FIG. 3 provides a block diagram illustrating the iteration administering system 300 in greater detail, in accordance with embodiments of the invention. As illustrated in FIG. 3, in one embodiment of the invention, the iteration administering system 300 includes one or more processing devices 320 operatively coupled to a network communication interface 310 and a memory device 330. In certain embodiments, the iteration administering system 300 is operated by a first entity, such as a financial institution, while in other embodiments, the iteration administering system 300 is operated by an entity other than a financial institution. In some embodiments, the iteration administering system 300 is owned or operated by the entity of the entity system 200. In some embodiments, the iteration administering system 300 may be an independent system. In alternate embodiments, the iteration administering system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the iteration administering system 300 described herein. For example, in one embodiment of the iteration administering system 300, the memory device 330 includes, but is not limited to, a network provisioning application 340, a requirement gathering application 350, a conflict identifier 360, an Natural Language Processing (NLP) application 370, decisioning application 380, an exposure identification application 385, and a data repository 390 comprising data processed or accessed by one or more applications in the memory device 330. The computer-executable program code of the network provisioning application 340, the requirement gathering application 350, the conflict identifier 360, the NLP application 370, the decisioning application 380, and the exposure identification application 385 may instruct the processing device 320 to perform certain logic, data-processing, and data-storing functions of the iteration administering system 300 described herein, as well as communication functions of the iteration administering system 300.

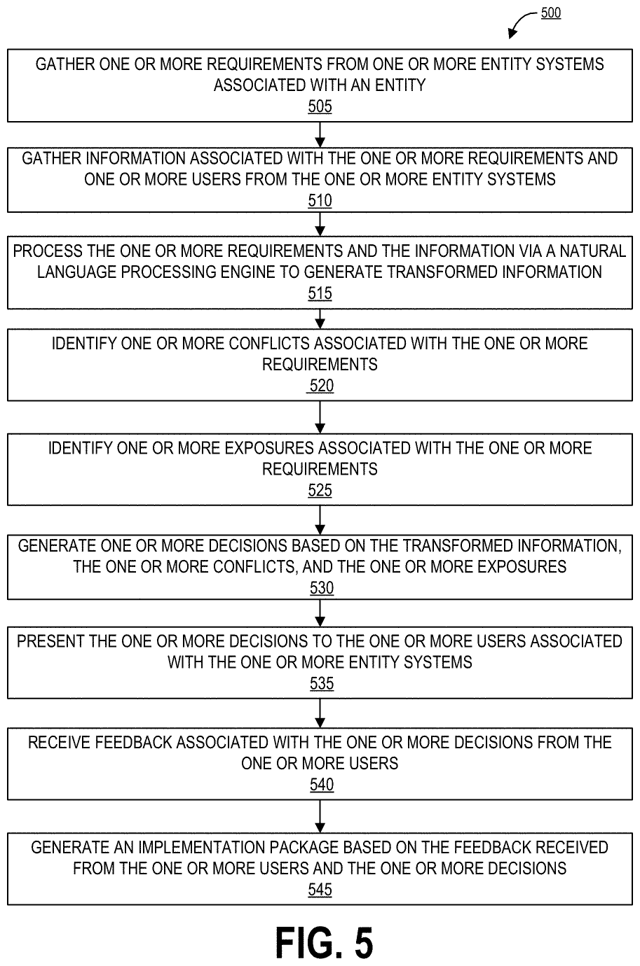

The network provisioning application 340, the requirement gathering application 350, the conflict identifier 360, the NLP application 370, the decisioning application 380, and the exposure identification application 385 are configured to invoke or use the data in the data repository 390 when communicating through the network communication interface 310 with the entity system 200, and/or the computing device system 400. In some embodiments, the network provisioning application 340, the requirement gathering application 350, the conflict identifier 360, the NLP application 370, the decisioning application 380, and the exposure identification application 385 may store the data extracted or received from the entity system 200, and the computing device system 400 in the data repository 390. In some embodiments, the network provisioning application 340, the requirement gathering application 350, the conflict identifier 360, the NLP application 370, the decisioning application 380, and the exposure identification application 385 may be a part of a single application. The network provisioning application 340 performs communication operations associated with the iteration administering system 300. The requirement gathering application 350 gathers one or more requirements and other information associated with the requirements. The conflict identifier 360 identifies one or more conflicts associated with the requirements and one or more teams implementing the requirements. The NLP application 370 understands the one or more requirements and passes on the transformed data to the decisioning application 380. The exposure identification application 385 identifies one or more exposures associated with fulfillment of the one or more requirements. The decisioning application 380 takes input from the conflict identifier 360, the NLP application 370, and the exposure identification application 385, and determines one or more assignments, where the one or more assignments comprise assignments of requirements to the one or more users, assignment of technology, assignment of iterations, or the like. The functionalities of the network provisioning application 340, the requirement gathering application 350, the conflict identifier 360, the NLP application 370, the decisioning application 380, and the exposure identification application 385 are explained in greater detail in FIG. 5.

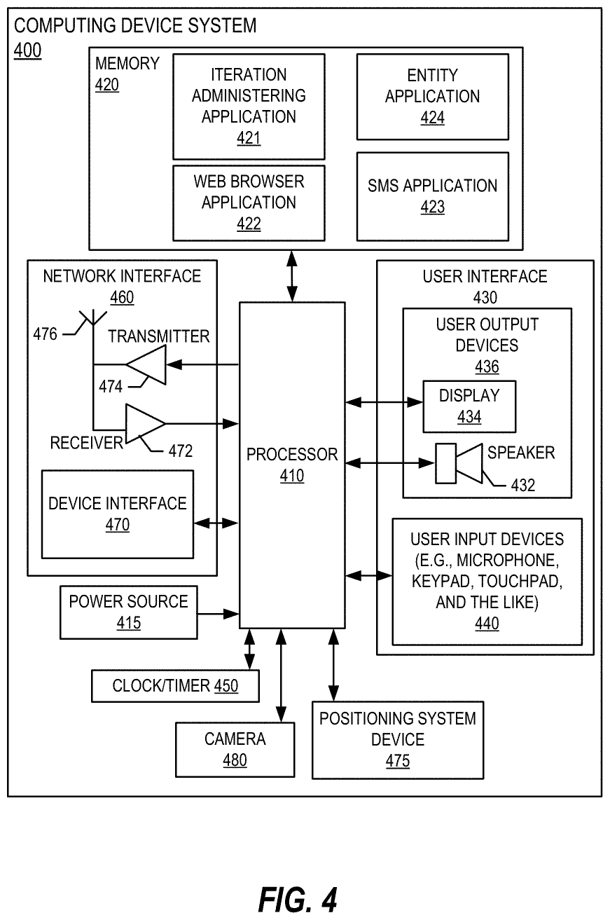

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an iteration administering application 421, entity application 424. These applications also typically comprise instructions to a graphical user interface (GUI) on the display 430 that allows the user 110 to interact with the entity system 200, the iteration administering system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the iteration administering application 421 provided by the iteration administering system 300 allows the user 110 to access the iteration administering system 300. In some embodiments, the entity application 424 provided by the entity system 200 and the iteration administering application 421 allow the user 110 to access the functionalities provided by the iteration administering system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a block diagram illustrating a process flow for automatically administering iterations in a continuous software development lifecycle framework, in accordance with an embodiment of the invention.

As shown in block 505, the system gathers one or more requirements from one or more entity systems associated with an entity. The one or more requirements as associated with organizational activities of an entity, where the one or more requirements are implemented by one or more entity systems comprising one or more entity applications. One or more users of the entity typically develop, maintain, test, and/or manage the one or more entity applications, where the one or more entity applications are configured to implement the one or more requirements and carry out of the organizational activities of the entity. In an embodiment where the entity is a financial institution, an entity application may be an online banking application that is configured to facilitate transactions, where the entity application is developed by one or more employees of the entity and utilized by other employees or customers of the entity to perform one or more financial related activities. In some embodiments, the one or more requirements may be stored in a data repository of the one or more entity systems. In some such embodiments, the one or more requirements are provided by one or more users (e.g., business analyst, architect, technical lead, and/or the like) of the entity.

As shown in block 510, the system gathers information associated with the one or more requirements and one or more users from the one or more entity systems. Information associated with the one or more requirements comprises completion date associated with the one or more requirements, complexity associated with each of the one or more requirements, technology information associated with historical requirements that are similar to the one or more requirements, assignment information associated with the historical requirements, time taken to complete the historical requirements, and/or the like. Information associated with the one or more users comprises specialization of technology and expertise associated with each of the one or more users, current assignment data of each of the one or more users (e.g., number of requirements that each user is working on currently and number of requirements that are currently assigned to the user), work schedule (e.g., number of work days, number of work hours, upcoming holidays, upcoming scheduled time off, and/or the like) of each of the one or more users, historical assignment completion data associated with each of the one or more users, and/or the like. In some embodiments, the system gathers the information associated with the one or more requirements and the one or more users from the one or more entity systems and/or software development lifecycle framework.

As shown in block 515, the system processes the one or more requirements and the information via a natural language processing engine to generate transformed information. The system uses the natural language processing engine to understand the one or more requirements and the information, where the natural language processing engine transforms the one or more requirements and the information into data that is understood by the system. The transformed data is then utilized by the system, to perform the steps described below.

As shown in block 520, the system identifies one or more conflicts associated with the one or more requirements. The one or more conflicts may be associated with the one or more users, one or more requirements, technology associated with the one or more requirements, completion dates associated with the one or more requirements, and/or the like. For example, the system may identify that a third requirement is dependent (e.g., add on, extension, or the like) on a first requirement of the one or more requirement, the system may identify such dependency as a conflict. In another example, the system may identify that only one testing engineer is available before completion data associated with at least one requirement and may determine such a scenario as a conflict. In another example, the system may determine that only one technology software license is available and there are two users that need to work on the technology software and may determine such a scenario as conflict. It should be understood that the examples described herein are for explanatory purposes only and in no way limit the scope of the invention.

As shown in block 525, the system identifies one or more exposures associated with the one or more requirements. The one or more exposures may be any delays that may be caused by the one or more conflicts which may result in not meeting the completion data allocated to the one or more requirements.

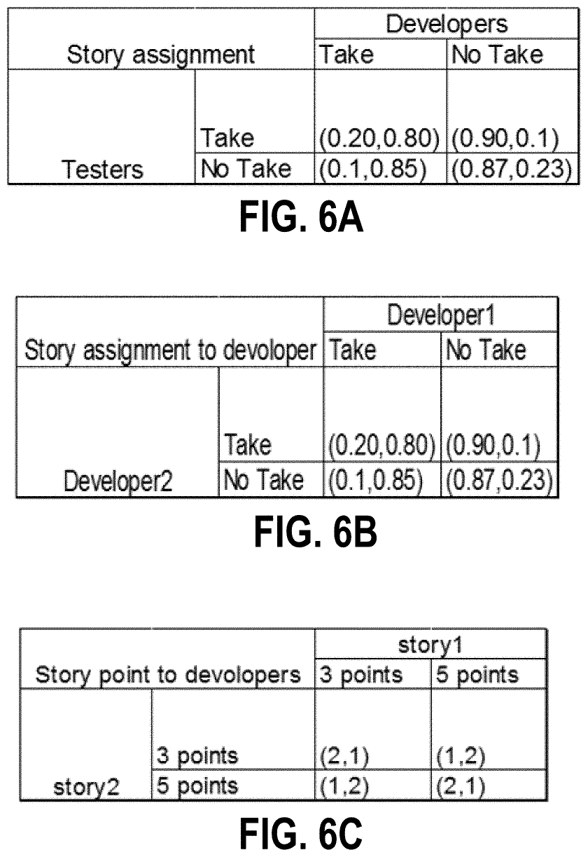

As shown in block 530, the system generates one or more decisions based on the transformed information, the one or more conflicts, and the one or more exposures. In some embodiments, the system uses a game theory engine and Nash equilibrium concept to generate the one or more decisions. Generating the one or more decisions comprises performing vectorization of the transformed information, the one or more conflicts, and the one or more exposures and generating one or more probabilities associated with the one or more requirements and the one or more users. An example of the probabilities generated by the system are shown in FIGS. 6A, 6B, and 6C. The one or more decisions generated by the system comprise at least assignment information associated with the one or more requirements to the one or more users, number of iterations to be administered in a software development lifecycle framework for the development, testing, and releasing of the one or requirements into a production environment, assignment of technology for the development of the one or more requirements, and the like. Software development lifecycle framework may be any framework utilized by the one or more users and the one or more entity systems of the entity to develop, maintain, test, and release the one or more entity applications into a production environment (e.g., where the one or more entity applications are used by customers and/or the one or more users of the entity in real-time).

As shown in block 535, the system presents the one or more decisions to the one or more users associated with the one or more entity systems. The system displays the one or more decisions to the one or more users via a graphical user interface on computing devices of the one or more users and prompts the one or more users to provide feedback associated with the one or more decisions. As shown in block 540, the system receives feedback associated with the one or more decisions from the one or more users. The one or more users may submit the one or more decisions via the graphical user interface provided by the system of the present invention on computing devices of the one or more users.

As shown in block 545, the system in response to receiving feedback from the one or more users generates an implementation package based on the feedback received from the one or more users and the one or more decisions. In some embodiments, the implementation package one or more executable instructions that cause the one or more entity systems and/or the one or more entity applications to automatically assign the one or more requirements to the one or more users and/or to automatically administer one or more iterations (e.g., iteration cycles and/or release cycles) in a software development lifecycle framework. Automatically administering the one or more iterations may comprise generating and pushing a piece of software code and/or data into the software development lifecycle framework, where the piece of software code and/or data automatically (i) assigns a value to the number of iterations/releases and/or (ii) generates iteration version number/release cycle version number ranges in the software development lifecycle framework.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for administering iterations in a continuous software development lifecycle framework, the system comprising:
a memory device with computer-readable program code stored thereon;
a communication device; and
a processing device operatively coupled to the memory device and the communication device, wherein the processing device is configured to execute the computer-readable program code to:
gather one or more requirements from one or more entity systems associated with an entity;
gather information associated with the one or more requirements and one or more users from the one or more entity systems, wherein the one or more users are associated with the entity;
process the one or more requirements and the information via a natural language processing engine to generate transformed information;
identify one or more conflicts associated with the one or more requirements;
identify one or more exposures associated with the one or more requirements; and
generate one or more decisions based on the transformed information, the one or more conflicts, and the one or more exposures.

2. The system according to claim 1, wherein the processing device is further configured to execute the computer-readable program code to:
present the one or more decisions to the one or more users associated with the one or more entity systems;
receive feedback associated with the one or more decisions from the one or more users; and
generate an implementation package based on the feedback received from the one or more users and the one or more decisions.

3. The system according to claim 2, wherein the processing device is further configured to execute the computer-readable program code to:
automatically administer iterations in a software development lifecycle framework based on the implementation package, wherein the implementation package comprises a number of the iterations associated with implementation of the one or more requirements, wherein administering the iterations comprises assigning one or more iterative version numbers in the software development lifecycle framework.

4. The system according to claim 2, wherein the processing device is further configured to execute the computer-readable program code to:
automatically assign each of the one or more requirements to the one or more users based on the generated implementation package, wherein the implementation package comprises assignments associated with each of the one or more requirements.

5. The system according to claim 1, wherein the one or more requirements are associated with organizational activities associated with the entity.

6. The system of claim 1, wherein the information associated with the one or more requirements comprises:
historical assignment data associated with one or more historical assignments;
technology data associated with the one or more historical assignments; and
user information associated with the one or more users.

7. The system according to claim 1, wherein the processing device is configured to generate the one or more decisions based on:
performing vectorization of the transformed information, the one or more conflicts, and the one or more exposures; and
generating one or more probabilities associated with the one or more requirements and the one or more users.

8. A computer program product for administering iterations in a continuous software development lifecycle framework, the computer program product comprising at least one non-transitory computer readable medium having computer-readable program code portions embodied therein, the computer-readable program code portions comprising executable portions for:
gathering one or more requirements from one or more entity systems associated with an entity;
gathering information associated with the one or more requirements and one or more users from the one or more entity systems, wherein the one or more users are associated with the entity;
processing the one or more requirements and the information via a natural language processing engine to generate transformed information;
identifying one or more conflicts associated with the one or more requirements;
identifying one or more exposures associated with the one or more requirements; and
generating one or more decisions based on the transformed information, the one or more conflicts, and the one or more exposures.

9. The computer program product of claim 8, wherein the computer-readable program code portions comprising executable portions for:
presenting the one or more decisions to the one or more users associated with the one or more entity systems;
receiving feedback associated with the one or more decisions from the one or more users; and
generating an implementation package based on the feedback received from the one or more users and the one or more decisions.

10. The computer program product of claim 9, wherein the computer-readable program code portions comprising executable portions for:
automatically administering iterations in a software development lifecycle framework based on the implementation package, wherein the implementation package comprises a number of the iterations associated with implementation of the one or more requirements, wherein administering the iterations comprises assigning one or more iterative version numbers in the software development lifecycle framework.

11. The computer program product of claim 9, wherein the computer-readable program code portions comprising executable portions for:
automatically assigning each of the one or more requirements to the one or more users based on the generated implementation package, wherein the implementation package comprises assignments associated with each of the one or more requirements.

12. The computer program product of claim 8, wherein generating the one or more decisions comprises:
performing vectorization of the transformed information, the one or more conflicts, and the one or more exposures; and
generating one or more probabilities associated with the one or more requirements and the one or more users.

13. The computer program product of claim 8, wherein the information associated with the one or more requirements comprises:
historical assignment data associated with one or more historical assignments;
technology data associated with the one or more historical assignments; and
user information associated with the one or more users.

14. A computer-implemented method for administering iterations in a continuous software development lifecycle framework, the method comprising:
gathering one or more requirements from one or more entity systems associated with an entity;
gathering information associated with the one or more requirements and one or more users from the one or more entity systems, wherein the one or more users are associated with the entity;
processing the one or more requirements and the information via a natural language processing engine to generate transformed information;
identifying one or more conflicts associated with the one or more requirements;
identifying one or more exposures associated with the one or more requirements; and
generating one or more decisions based on the transformed information, the one or more conflicts, and the one or more exposures.

15. The computer-implemented method of claim 14, wherein the method further comprises:
presenting the one or more decisions to the one or more users associated with the one or more entity systems;
receiving feedback associated with the one or more decisions from the one or more users; and
generating an implementation package based on the feedback received from the one or more users and the one or more decisions.

16. The computer-implemented method of claim 15, wherein the method further comprises:
automatically administering iterations in a software development lifecycle framework based on the implementation package, wherein the implementation package comprises a number of the iterations associated with implementation of the one or more requirements, wherein administering the iterations comprises assigning one or more iterative version numbers in the software development lifecycle framework.

17. The computer-implemented method of claim 15, wherein the method further comprises automatically assigning each of the one or more requirements to the one or more users based on the generated implementation package, wherein the implementation package comprises assignments associated with each of the one or more requirements.

18. The computer-implemented method of claim 14, wherein generating the one or more decisions comprises:
performing vectorization of the transformed information, the one or more conflicts, and the one or more exposures; and
generating one or more probabilities associated with the one or more requirements and the one or more users.

19. The computer-implemented method of claim 14, wherein the information associated with the one or more requirements comprises:
historical assignment data associated with one or more historical assignments;
technology data associated with the one or more historical assignments; and
user information associated with the one or more users.

20. The computer-implemented method of claim 14, wherein the one or more requirements are associated with organizational activities associated with the entity.
